(19) United States
(12) Patent Application Publication
(10) Pub. No.: US 2007/0159292 A1
(43) Pub. Date: Jul. 12, 2007

(54) Over-current protector

(76) Inventors: Kun-Huang Chang, Miaoli (TW); Wen-Lung Liu, Miaoli (TW)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/651,991

(22) Filed: Jan. 11, 2007

(30) Foreign Application Priority Data
Jan. 12, 2006 (TW) 095101222

(51) Int. Cl. H01H 85/38; H01H 85/18

(52) U.S. Cl. 337/159; 337/276; 337/273

(57) ABSTRACT

An over-current protective device is characterized by comprising: a fuse cover, a fusible body disposed therein, and a first electrode and a second electrode respectively extending from the two ends of the fusible body. A method for fabricating the over-current protective device comprises the following steps: stamping a conductive metal sheet to form a frame with a base having two ends respectively extending as a supporting plate, and soldering a fusible unit containing the fusible body between the supporting plates; disposing the frame having the soldered fusible unit into a mold, putting a polymeric material into the mold for covering the fusible body and the supporting plates, and molding the fusible body into a required shape; taking out the frame covered by the polymeric material and cutting the base off so as to obtain an over-current protective device having two electrode plates extending from two ends thereof.

### FIELD OF THE INVENTION

The present invention relates to an over-current protector and a method of manufacturing the same, particularly to an over-current protector and a method of manufacturing the same which are used indelicate electronic equipment to protect the equipment.

### DESCRIPTION OF THE PRIOR ART

A fuse is used to protect an electronic or electrical device in an electric circuit from transient over current or voltage. Therefore, the fuse is an indispensable electronic device. A conventional fuse has a coil or fuse material. The fuse material is sealed in a tube that is made of a glass material, ceramic or other insulating materials. The tube is filled with an insert gas or a filler that may withstand an electric arc. The tube has two conductors at two ends of the tube. The two conductors are connected to a printed circuit board through a soldering contact so that the current may pass the fuse. When the transient current exceeds a predetermined level, the fuse will break due to the heat induced by the transient current so that the over current will not pass through the circuit. Such a structure will produce extremely large transient energy at a larger current (such as 240 A) and larger voltage (such as 2250V). When the fuse is being melted due to the heat, surrounding media will expand rapidly so that the tube will explode. In the meantime, an arc will be induced during the explosion. The arc will destroy surrounding electronic devices and expensive equipment. Conventional fuses include the following structures and properties:

(1) U.S. Pat. No. 6,507,264

A fuse and a semiconductor device (such as a thyrister) are packaged as a module by using semiconductor package technologies. The fuse is packaged by ceramics, glasses, PTFE, Melamine, etc. The module contains an over-current and over-voltage protective element and has three terminals. The three terminals are connected to the protective system in series. The over-voltage protective element is connected to the protective system in parallel to achieve the over-current and over-voltage protective functions.

(2) U.S. Pat. No. 5,572,181

A fusible link is encapsulated by glass powder of a low melting point. The glass powder fills the encapsulant of semiconductor resin. The melting point of the glass powder is lower than that of the fusible link. When the fusible link is melted, the glass powder will be melted as to destroy the conducting path.

(3) U.S. Pat. No. 5,923,239

A fusible material is deposited on a printed circuit board and then covered by a film of polymeric material. The polymeric material, fusible material and the printed circuit board are laminated. The main feature is that the over-current protective device is formed by utilizing a PCB material to encapsulate the fusible link.

(4) U.S. Pat. No. 6,507,265

This U.S. patent is characterized in that chamber is filled with filler material that can reduce arc energy. The filler material includes silica sand, powdered gypsum, inert gases, and the like.

(5) U.S. Pat. No. 5,812,046

A subminiature fuse is filled with a gas with arc quenching properties. The gas includes SF6 or N₂.

(6) U.S. Pat. No. 5,596,306

This patent uses a silicone rubber sealant. The sealant may flow at room temperature, but it will become solid because its viscosity will increase in the air. The solid sealant may be used for depressing arcs.

In view of the above, many companies developed over-current protection devices. The prior devices and their manufacturing methods are complicated. In the market, developing a fuse that can withstand huge currents and voltages and will not explode or produce arcs is desired, as is a fuse that is cheap and easy to manufacture.

### SUMMARY OF THE INVENTION

The present invention is aimed at providing an over-current protective device and a method of manufacturing the same, especially an over-current protective device that can be used in computers and precise telecommunications equipment.

The device of the present invention may be manufactured by traditional tools such as a punching machine, soldering machine, mold, and coating machine, without using particular machines. Therefore, the manufacturing method is simplified, and the cost and required equipment is reduced.

According to an embodiment of the present invention, the over-current protective device can be patterned by the punching machine and the soldering machine to obtain a substrate that is different from prior substrates. The contour or shape of the substrate may be flat and thin, circular, rectangular, or elliptical to meet different requirements.

According to embodiments of the present invention, the electrodes at the two ends of the fusible device may have a variety of shapes or structures. Therefore, the fusible device may be applied to many situations.

To achieve the above objectives, the present invention provides an over-current protector, comprising: a fuse body, a first electrode and a second electrode respectively extending from the two ends of the fuse body; and a fuse encapsulant made of a polymer material; wherein the encapsulant is able to absorb the heat induced from a fuse body that is melted and depress arc. The molecular weight of the polymer material is in a range between 3,000 and 10,000,000. a flexible material can be added to the polymer material. The polymer material is a thermal-plastic material or a thermal-set material.

The present invention further provides a method of fabricating an over-current protector, comprising the following steps: stamping a conductive metal sheet to form a frame with at least one base from which supporting plates extend (step 301); soldering a fusible unit containing a fuse body between the support plates (step 303); disposing the frame which has the soldered fusible unit into a mold (step 305); putting a polymer material into the mold for covering the fuse body and a portion of the support plates as well as molding the fuse body and the support plates into a required shape; and taking out the frame covered by the polymer material and severing the base (step 307).

### BRIEF DESCRIPTION OF THE DRAWING

FIG. 1 shows a frame for manufacturing a fusible device of the present invention.

FIG. 2 is a schematic diagram of the fusible element of the present invention.

FIG. 3 is a flow chart for manufacturing the fusible device of the present invention.

### DETAILED DESCRIPTION OF THE INVENTION

### Embodiment 1

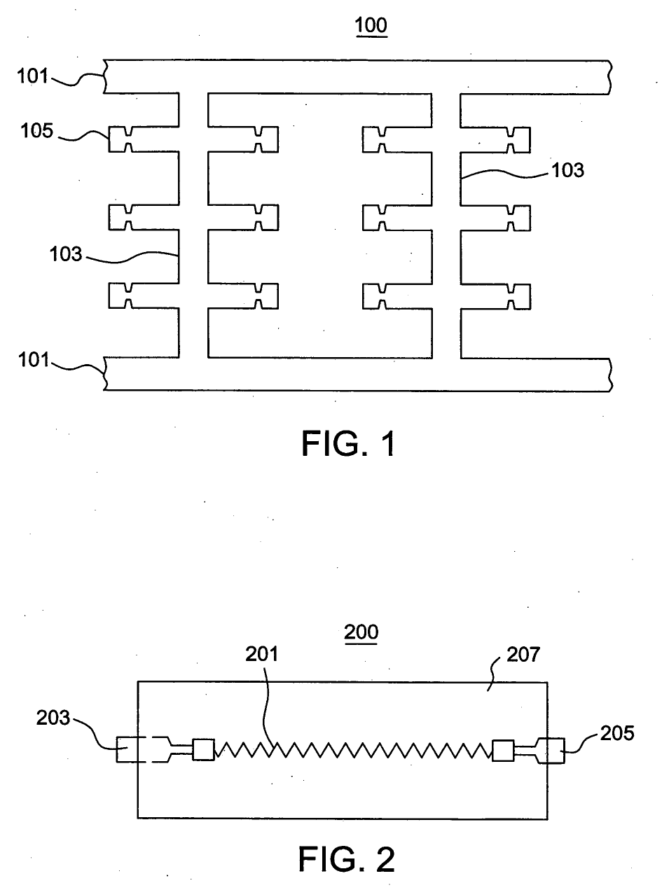

As shown in FIG. 1, a thin plate is punched to form a frame 100. The frame 100 is formed with bases 101. Plural supporting plates 103 are connected between the bases 101. Plural fusible units 105 are extended from the supporting plates 103. The thin plate is formed by using the following conditions:
40 wt % PBT (Polybuty Terephthlate), MI=10 g/10 min, Al(OH)₃ of average diameter of 1 μm, short 20 wt % fiber glass of ⅙ inch long, 0.2 wt % anti-oxidant

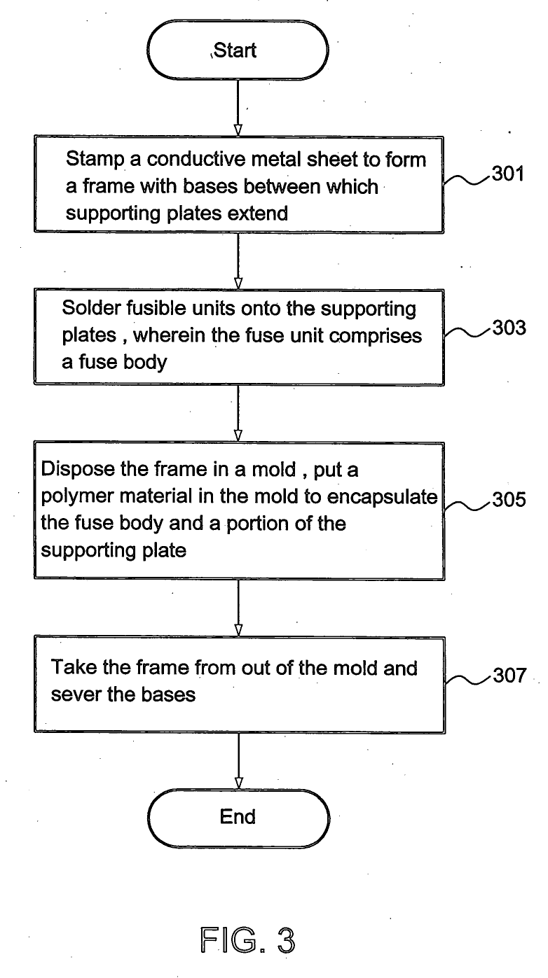

The thin plate is formed by a co-rotation bi-helical injection machine (φ=50 mm), wherein the blending temperature is 260-300° C., and the rotation speed of the driving screw is 200 rpm. The length of the fusible unit 105 is 10 mm. The diameter of the fusible unit 105 is 0.13 mm. The fusible unit 105 is coated with a silver layer of 12 μm and a tin layer of 7 μm. The fusible unit is then wound onto a ceramic fiber to form an elongated structure. The frame 100 with the fusible units 105 is put into a mold. Plastic powder in conjunction with AlOH and glass fiber is injected into the mold to encapsulate the fusible units 105 and a part of the supporting plates 103. The encapsulated fusible unit is then taken from the mold. The bases 101 are cut off, so that a fusible device is provided with two electrode plates at two ends of the fusible device. The method of manufacturing the fusible device comprises steps 301-307 shown in FIG. 3.

FIG. 2 shows a fusible device 200. The fusible device 200 comprises a fusible body 201 with a first electrode 203 and second electrode 205 at its two ends. The body 201 is encapsulated by an encapsulant 207. Test results of the fusible device 200 are indicated in Tables 1A-1E.

TABLE 1A

| | | Time (represented by %) larger than rated | |
|---|---|---|---|
| | | current (1.25 A) 100% | |
| No | DC current (μA) | 100% | 250% |
| 1 | 96 | Larger than 4 hours | 100 seconds |
| 2 | 94 | Larger than 4 hours | 96 seconds |
| 3 | 99 | Larger than 4 hours | 91 seconds |
| 4 | 96 | Larger than 4 hours | 105 seconds |
| 5 | 92 | Larger than 4 hours | 98 seconds |

TABLE 1B

| | Surge AC | Surge | | | | | | | |
|---|---|---|---|---|---|---|---|---|---|
| | Voltage | Current | Lasting | | Sample | Sample | Sample | Sample | Sample |
| No. | (VAC) | (A) | time | | 1 | 2 | 3 | 4 | 5 |
| 1 | 50 | 0.33 | 15 | minutes | ok | ok | ok | ok | ok |
| 2 | 100 | 0.17 | 15 | minutes | ok | ok | ok | ok | ok |
| 3 | 600 | 1.0 | 1.0 | minute | ok | ok | ok | ok | ok |

TABLE 1C

| | Surge | Surge | | Number | | | | | |
|---|---|---|---|---|---|---|---|---|---|
| | Voltage | Voltage | Surge | (Positive/Negative | Sample | Sample | Sample | Sample | Sample |
| No. | (VAC) | (A) | Waveform | direction) | 1 | 2 | 3 | 4 | 5 |
| 1 | 600 | 100 | 10/1000 | +/−25 | ok | ok | ok | ok | ok |
| 2 | 1000 | 100 | 10/1000 | +/−25 | ok | ok | ok | ok | ok |
| 3 | 1000 | 100 | 10/360 | +/−25 | ok | ok | ok | ok | ok |
| 4 | 2500 | 500 | 2/10 | +/−10 | ok | ok | ok | ok | ok |

TABLE 1D

| | Surge | | | | | | | | |
|---|---|---|---|---|---|---|---|---|---|
| | Voltage | Surge | | | Sample | Sample | Sample | Sample | Sample |
| No. | (VAC) | Current (A) | Lasting time | | 1 | 2 | 3 | 4 | 5 |
| 1 | 277 | 25 | 15 | minutes | ok | ok | ok | ok | ok |
| 2 | 600 | 2.2 | 15 | minutes | ok | ok | ok | ok | ok |
| 3 | 600 | 7.0 | 5.0 | seconds | ok | ok | ok | ok | ok |
| 4 | 600 | 60 | 5.0 | seconds | ok | ok | ok | ok | ok |

TABLE 1E

| | Surge | Surge | | | | | | | |
|---|---|---|---|---|---|---|---|---|---|
| | Voltage | Current | Surge | | Sample | Sample | Sample | Sample | Sample |
| No. | (VAC) | (A) | Waveform | Number | 1 | 2 | 3 | 4 | 5 |
| 1 | 5000 | 500 | 2/10 | 1 | ok | ok | ok | ok | ok |

### Embodiment 2

With reference to FIG. 1 again, an encapsulant material for the fusible unit 105 is the same as that of embodiment 1. A thin plate is punched to form a frame 100. The frame 100 is formed with bases 101. Plural supporting plates 103 are connected between the bases 101. Plural fusible units 105 are extended from the supporting plates 103. The fusible unit 105 is coated by a thermally insulating layer of Teflon of a thickness of 0.1-0.5 mm. The frame 100 with the fusible units 105 is put into a mold. Plastic powder in conjunction with AlOH and glass fiber is injected into the mold to encapsulate the fusible units 105 and a part of the supporting plates 103. The encapsulated fusible unit is then taken from the mold. The bases 101 are cut off, so that a fusible device is provided with two electrode plates at two ends of the fusible device. The method of manufacturing the fusible device comprises steps 301-307 shown in FIG. 3.

FIG. 2 shows a fusible device 200 manufactured by the method. The fusible device 200 comprises a fusible body 201 with a first electrode 203 and second electrode 205 at its two ends. The body 201 is encapsulated by an encapsulant 207. Test results of the fusible device 200 are indicated in Tables 2A -2E.

TABLE 2A

Time (represented by %) larger than
rated current (1.25 A) 100%

| No | DC current (μA) | 100% | 250% |
|---|---|---|---|
| 1 | 101 | Larger than 4 hours | 33 seconds |
| 2 | 94 | Larger than 4 hours | 38 seconds |
| 3 | 93 | Larger than 4 hours | 40 seconds |
| 4 | 98 | Larger than 4 hours | 35 seconds |
| 5 | 92 | Larger than 4 hours | 43 seconds |

TABLE 2B

| | Surge | Surge | | | | | | | |
|---|---|---|---|---|---|---|---|---|---|
| | AC | Current | | | Sample | Sample | Sample | Sample | Sample |
| No. | Voltage (VAC) | (A) | Lasting time | | 1 | 2 | 3 | 4 | 5 |
| 1 | 50 | 0.33 | 15 | minutes | ok | ok | ok | ok | ok |
| 2 | 100 | 0.17 | 15 | minutes | ok | ok | ok | ok | ok |
| 3 | 600 | 1.0 | 1.0 | second | ok | ok | ok | ok | ok |

TABLE 2C

| | Surge | Surge | | Number | | | | | |
|---|---|---|---|---|---|---|---|---|---|
| | Voltage | Voltage | Surge | (Positive/Negative | Sample | Sample | Sample | Sample | Sample |
| No. | (VAC) | (A) | Waveform | direction) | 1 | 2 | 3 | 4 | 5 |
| 1 | 600 | 100 | 10/1000 | +/−25 | ok | ok | ok | ok | ok |
| 2 | 1000 | 100 | 10/1000 | +/−25 | ok | ok | ok | ok | ok |
| 3 | 1000 | 100 | 10/360 | +/−25 | ok | ok | ok | ok | ok |
| 4 | 2500 | 500 | 2/10 | +/−10 | ok | ok | ok | ok | ok |

TABLE 2D

| | Surge | Surge | | | | | | | |
|---|---|---|---|---|---|---|---|---|---|
| | Voltage | Current | Lasting | | Sample | Sample | Sample | Sample | Sample |
| No. | (VAC) | (A) | time | | 1 | 2 | 3 | 4 | 5 |
| 1 | 277 | 25 | 15 | minutes | ok | ok | ok | ok | ok |
| 2 | 600 | 2.2 | 15 | minutes | ok | ok | ok | ok | ok |
| 3 | 600 | 7.0 | 5.0 | seconds | ok | ok | ok | ok | ok |
| 4 | 600 | 60 | 5.0 | seconds | ok | ok | ok | ok | ok |

TABLE 2E

| | Surge | Surge | | | | | | | |
|---|---|---|---|---|---|---|---|---|---|
| | Voltage | Current | Surge | | Sample | Sample | Sample | Sample | Sample |
| No. | (VAC) | (A) | Waveform | Number | 1 | 2 | 3 | 4 | 5 |
| 1 | 5000 | 500 | 2/10 | 1 | ok | ok | ok | ok | ok |

The thermal-plastic material comprises: (a) crystalline polymer: polyethylene, polypropylene, nylon 12, nylon 6, nylon 66, nylon 6T, nylon 9T, polybutylene terephthalate, polyethylene terephthalate, polyoxymethylene, PEEK, liquid crystal polymer, ethylene copolymer, or polyphenylene sulfide; (b) amorphous polymer: acrylonitrile-butadiene-styrene copolymer, polystyrene, polysulfonate, polydiethyl ether sulfonate, polystyrene oxide, phenoxy resin, polyamide, polyether amide, polyether amide/silicon block copolymer, polycarboxylate, propylene resin, polymethacrylate, styrene, poly(4-methyl-1-pentene), or styrene block copolymer.

The fusible device of the present invention is thin and thus the volume of the fusible device is greatly reduced. Thus, the fusible device of the present invention meets the requirements for being compact and light in weight. The fusible device of the present invention needs only the steps of punching, soldering, and filling a polymeric encapsulating material. The step of cutting the frame is simplified. The fusible device of the present invention can be achieved without using expansive machines. Thus, the production cost is reduced.

It should be understood that the embodiments described above are only preferred embodiments of the present invention. Modifications made according to the concept of the present invention and their functions do not depart from the spirit of the present invention covered by the specification and the drawings and should be included within the scope of the claims.

What is claimed is:

1. An over-current protector, comprising:
a fuse body, a first electrode and a second electrode respectively extending from the two ends of the fuse body; and
a fuse encapsulant made of a polymer material;
wherein the encapsulant is able to absorb the heat induced from a fuse body that is melted and depress arc.

2. The over-current protector of claim 1, wherein the molecular weight of the polymer material is in a range between 3,000 and 10,000,000.

3. The over-current protector of claim 2, wherein the polymer material is a thermal-plastic material or a thermal-set material.

4. The over-current protector of claim 3, wherein the thermal-plastic material comprises: (a) crystalline polymer: polyethylene, polypropylene, nylon 12, nylon 6, nylon 66, nylon 6T, nylon 9T, polybutylene terephthalate, polyethylene terephthalate, polyoxymethylene, PEEK, liquid crystal polymer, ethylene copolymer, or polyphenylene sulfide; (b) amorphous polymer: acrylonitrile-butadiene-styrene copolymer, polystyrene, polysulfonate, polydiethyl ether sulfonate, polystyrene oxide, phenoxy resin, polyamide, polyether amide, polyether amide/silicon block copolymer, polycarboxylate, propylene resin, polymethacrylate, styrene, poly(4-methyl-1-pentene), or styrene block copolymer.

5. The over-current protector of claim 3, wherein an anti-oxidant or a filler can be added to the polymer material.

6. The over-current protector of claim 3, wherein a flexible material can be added to the polymer material.

7. The over-current protector of claim 3, wherein an inorganic fiber, an organic fiber or an arc-bearable hydroxide can be added to the polymer material.

8. A method of fabricating an over-current protector, comprising the following steps:
stamping a conductive metal sheet to form a frame with at least one base from which supporting plates extend;
soldering a fusible unit containing a fuse body between the support plates;
disposing the frame which has the soldered fusible unit into a mold;
putting a polymer material into the mold for covering the fuse body and a portion of the support plates as well as molding the fuse body and the support plates into a required shape; and
taking out the frame covered by the polymer material and severing the base.
